(19) United States
(12) Patent Application Publication
(10) Pub. No.: US 2003/0225946 A1
(43) Pub. Date: Dec. 4, 2003

(54) Method and apparatus for peripheral progress metering

(76) Inventors: Kram Henry Allen, Meridian, ID (US); Linn James Kropf, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/160,298

(22) Filed: May 31, 2002

(51) Int. Cl. G06F 3/00

(52) U.S. Cl. 710/8

(57) ABSTRACT

A peripheral, such as a multifunction peripheral, printer, fax machine, digital copier, or other output device, includes a display for peripheral progress metering. The display is configured to present, to users, representations of jobs resident within a job queue. Each representation may include a job owner indicator and a job length indicator. A user interface driver is configured to control the display.

### TECHNICAL FIELD

This disclosure relates to a progress meter, which provides information concerning jobs being processed by a peripheral or other output device.

### BACKGROUND

The output quality, duty cycle and plurality of functions offered by many multifunction peripherals (MFPs) invites their configuration in a network environment, wherein they may be utilized by a number of users. Accordingly, it is frequently the case that a network environment will be employed to allow a group of co-workers to share a multifunction peripheral. Accordingly, all the users will be able to send jobs from a workstation to be printed; send and receive faxes; scan documents; copy documents and perform other tasks. While most of the use of the multifunction peripheral by the group will be somewhat evenly distributed over time, it may be the case that, on occasion, a number of users will have to wait their turn for completion of their task.

During periods when a number of jobs are sent to the MFP, several people may gather around the MFP, wondering when their job will be completed. Due to uncertainty over the length and number of jobs to be performed, the duration of the wait experienced by users waiting for completion of their job may be difficult to estimate. This may cause some frustration, and result in time poorly spent by workers who arrive at the MFP prior to job completion, and who have no knowledge of the quantity and length of the jobs ahead of their job.

### SUMMARY

A peripheral, such as a multifunction peripheral (MFP), printer, fax machine, digital copier, or other output device, includes a display for peripheral progress metering. The display is configured to present, to users, representations of jobs resident within a job queue. Each representation may include a job owner indicator and a job length indicator. A user interface driver is configured to control the display.

### BRIEF DESCRIPTION OF THE DRAWINGS

The same reference numbers are used throughout the drawings to reference like features and components.

FIG. 1 is an illustration of a system environment in which an embodiment of a progress meter on a peripheral is operational.

FIG. 2 is an illustration of a second embodiment of the progress meter.

FIG. 3 illustrates an embodiment of a webpage-based user interface.

FIG. 4 illustrates an embodiment of hardware and software present on an exemplary peripheral configured to include a progress meter.

FIG. 5 is a flow chart illustrating an embodiment for displaying information to the users of peripherals, allowing them to better predict the time of their job's completion.

FIG. 6 is a flow chart illustrating additional functionality optionally incorporated in the embodiment of FIG. 5.

### DETAILED DESCRIPTION

A progress meter for a peripheral facilitates operation by allowing users to see a visual display of representations of jobs moving through a job completion process, each representation typically including a job owner indicator and a job length indicator. A user interface driver is configured to control the visual display. Job owners may easily see a representation of their job on the display, as well as other jobs and their lengths, and thereby estimate the time of completion of their job.

In a variation of the progress meter, an embedded web server sends a webpage interface to a user's workstation. The webpage is configured to provide an alternate display of the progress meter, and to allow users to select job priority for the jobs over which they exert ownership. In a second variation of the progress meter, a fax modem and fax upload/download utility are configured to obtain ownership and length information regarding incoming faxes, and to exhibit the information in the display. In a still further variation, an input mechanism is configured to alter the status of jobs shown by the progress meter, such as to change the status to urgent, thereby resulting in processing prior to jobs of a lower status.

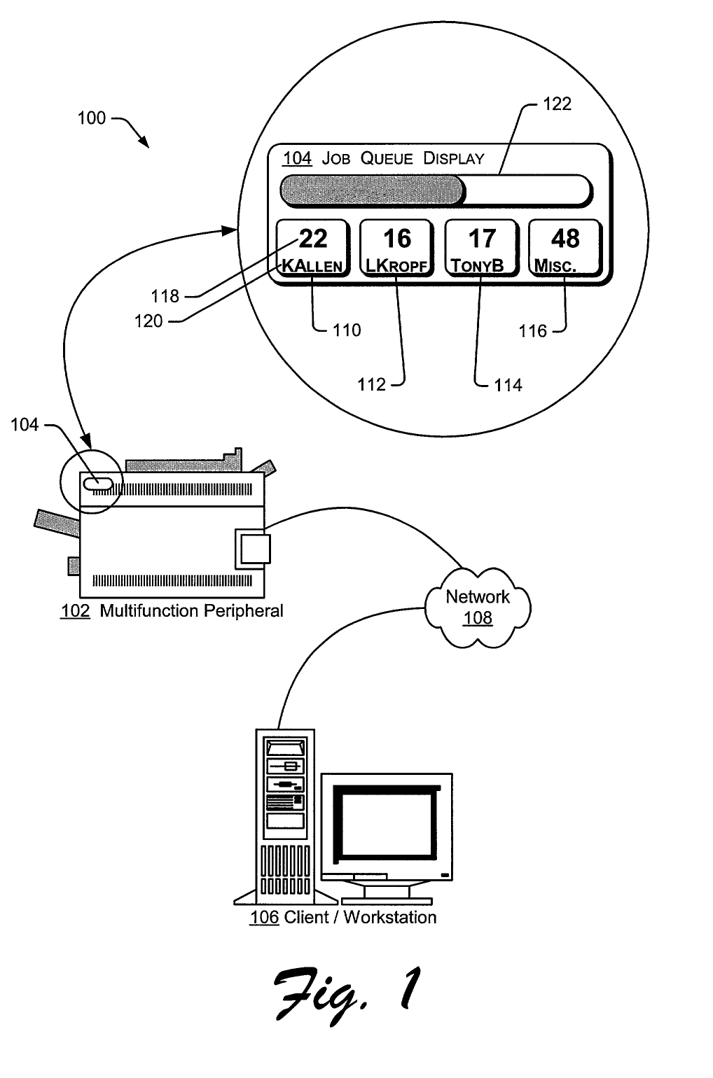

FIG. 1 shows a system environment 100 in which a peripheral, illustrated for purposes of example as a multifunction peripheral (MFP) 102, facilitates job management with a progress meter or display 104. The MFP or other peripheral may be based on inkjet, laser or other technology, and may include printing, fax sending/receiving, copying, scanning and other functionality. While a peripheral such as an MFP is disclosed in the exemplary system, a printer, fax machine, digital network copier or other output device could be substituted. The system environment may include a client workstation 106 communicating with the MFP by means of a network 108. The network may be a local area network (LAN), a wide area network (WAN), the Internet or other network type, technology and/or topology.

The progress meter or display 104 carried by the MFP provides a visual indication of the jobs currently being processed by the MFP. The jobs may be print jobs, copy jobs, incoming or outgoing faxes, scanning jobs or other jobs for which the MFP is configured to accomplish. The progress meter may consist of an LCD (liquid crystal display) or other output device. Four icons or representations of jobs 110, 112, 114 and 116 are associated with print, copy, scan or fax jobs currently in the work queue of the MFP. Each representation illustrates a job having a length indicator 118 and a job owner indicator 120. The length indicator typically expresses the length of the job in terms of pages not yet processed; accordingly, the length indicator of a first print job representation within the print queue is decremented as the job is performed. For example, as a fax is received, the total number of remaining pages is decremented as each page of the fax is received. The job owner indicator typically expresses ownership of the job in terms of the user name of the operator of the workstation from which the print job originated. Where the job is a copy or scan job that does not originate from a workstation, the job owner indicator may include a generic term, such as copy1, or scan1; alternatively, where the user must key in a password to use the MFP, the copy or scan job may reflect the user's name. Due to the job owner indicator, MFP users can therefore easily recognize their job, and determine the job's position within the job queue.

An optional percentage of completion graphic, such as bar graph 122 or a pie chart, provides an at-a-glance visual indication of an approximate percentage of completion of a job currently being processed. For example, in FIG. 1, it appears that KAllen's job is just over half completed, since the bar graph is just over half filled in. When KAllen's job is completed, LKropf's job will begin, and the bar graph, pie chart, or other graphic, will begin to fill in to reflect progress made in completing that job.

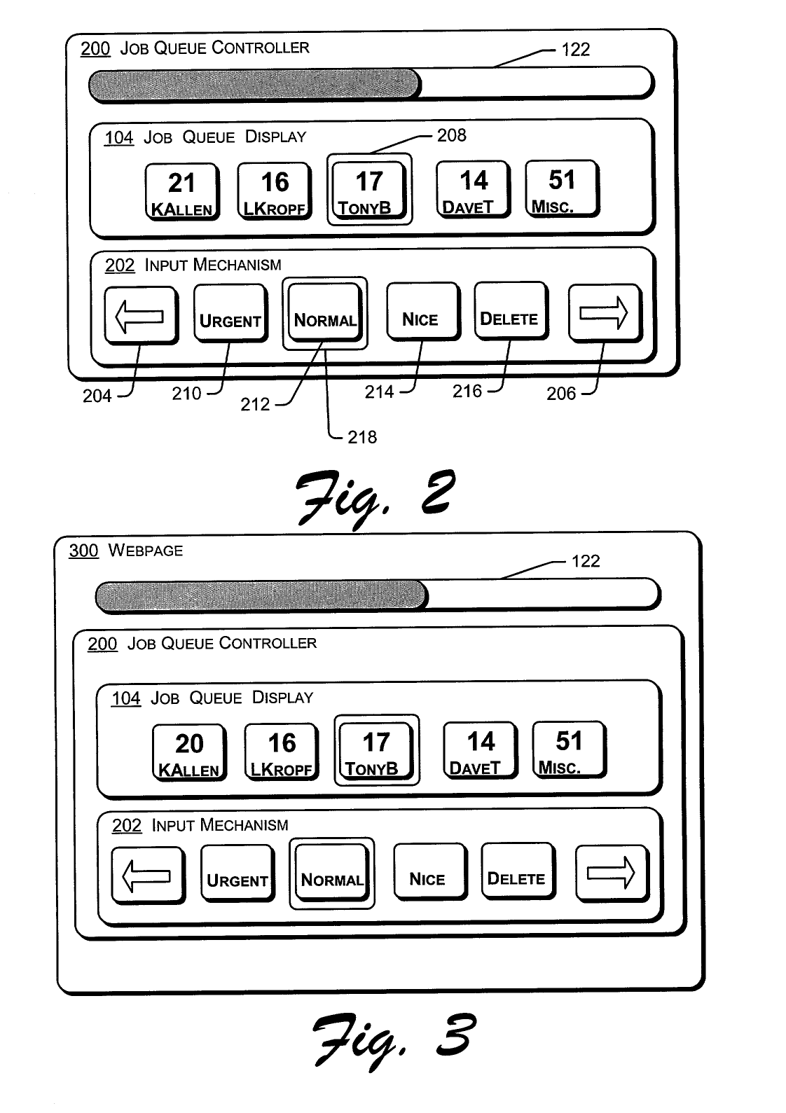

FIG. 2 shows an embodiment of a job queue controller 200 having a job queue display 104, a bar graph 122, and an input mechanism 202 that accepts commands from a user. The input mechanism may consist of a keypad or other input device. As seen in FIG. 2, left and right arrows 204, 206 assist in moving an indicator 208 or highlight to select one of the job representations. As seen in FIG. 2, a 17-page job owned by TonyB is selected. Use of the left and right arrow keys 204, 206 would result in selection of the 16-page print job owned by LKropf or the 14-page print job owned by DaveT, respectively.

Once selected, the status of the job may be altered by selecting a key on the keypad or other input device 202. As seen in FIG. 2, the “normal” setting is highlighted or selected, such as by a lighted button 218 or highlighted touch screen. Four exemplary status choices are illustrated, including urgent 210, normal 212, nice 214 and delete 216. Selection of normal allows the job to be printed in a normal course, i.e. in its chronological order with respect to other print jobs. Selection of urgent results in printing immediately after completion of the current job, and after any earlier-sent urgent job within the job queue. Selection of nice results in any normal or urgent job passing the nice job within the job queue; accordingly, nice jobs are performed only after the job queue has emptied of urgent and normal jobs. Selection of delete removes the job from the job queue.

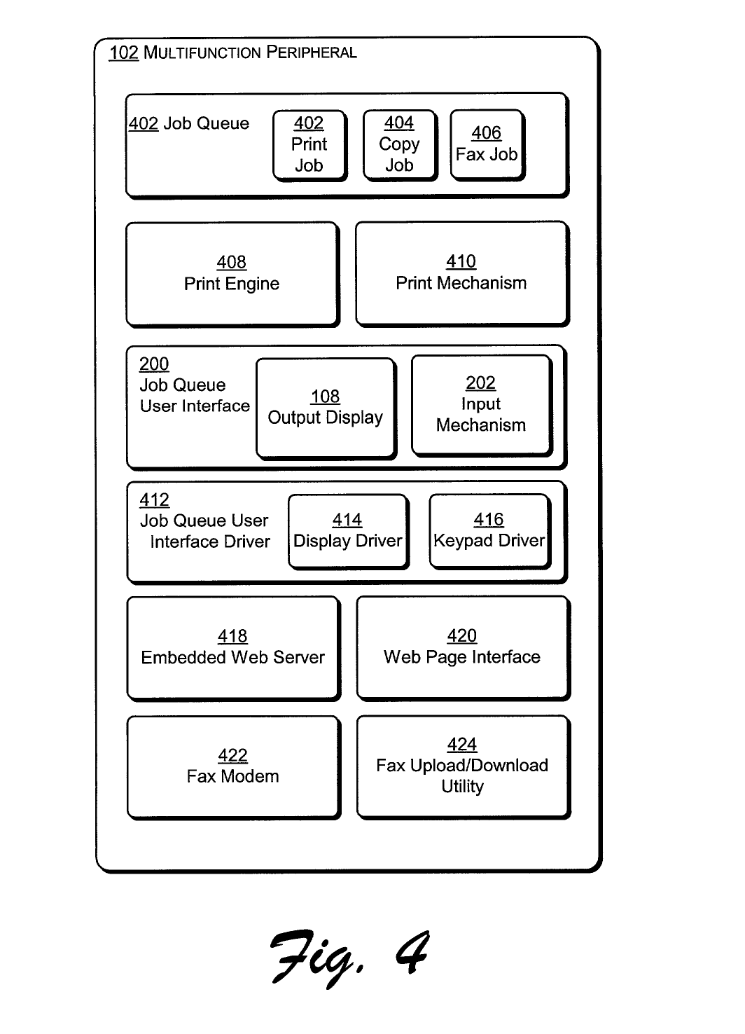

FIG. 3 shows an embodiment of a webpage interface 300, which includes a job queue controller 200, formed of a progress meter such as display 104, a bar graph 122, and optionally an input mechanism 202. The webpage interface is sent to a workstation by a web server embedded within the MFP, as will be discussed further in the dialogue associated with FIG. 4. The webpage interface may be displayed on a user's workstation by browser software, such as NETSCAPE® software or EXPLORER® software. The exemplary webpage interface provides a progress meter or display 104, a bar graph 122 or similar percentage of completion indicating graphic, and optionally an input mechanism 202. A user may operate the input mechanism by pointing and clicking a mouse, or by other means, as desired.

FIG. 4 shows a block diagram illustrating an embodiment of hardware and software structures contained within the MFP 102 or other output device. A job queue 402 contains three jobs, a print job 402, a copy job 404 and a fax job 406. The print, copy, incoming fax and other appropriate jobs are rasterized by a print engine 408, after which an image is applied to media by a print mechanism 410.

A job queue user interface 200 includes an output device 108, such as an LCD display. An optional input mechanism 202 can use touch screen or keypad technology. The job queue user interface is supported by a job queue user interface driver 412. The job queue user interface driver may be segmented or otherwise organized to include a display driver 414, which supports operation of the output display 108, and an input mechanism or keypad driver 416, which supports operation of the input mechanism 202.

An embedded web server 418 serves or sends a webpage interface 420 in response to a request received from a browser operating on a client workstation. The webpage interface may appear similar to the exemplary webpage illustrate in FIG. 3.

A fax modem 422 and fax upload/download utility 424 may be present where the MFP or other output device includes fax functionality. The fax upload/download utility is configured to attempt to determine the ownership of an incoming fax, as well as the expected number of pages to be received. In many cases, the length of the fax is known, since the sending fax machine buffered the entire fax into memory prior to transmission, and is therefore configured to state, with or without prompting, the length of the fax. The fax upload/download utility is configured to communicate information concerning an incoming fax to the job queue user interface driver 412; such information may include: the existence of the fax; the ownership of the fax; and the length of the fax.

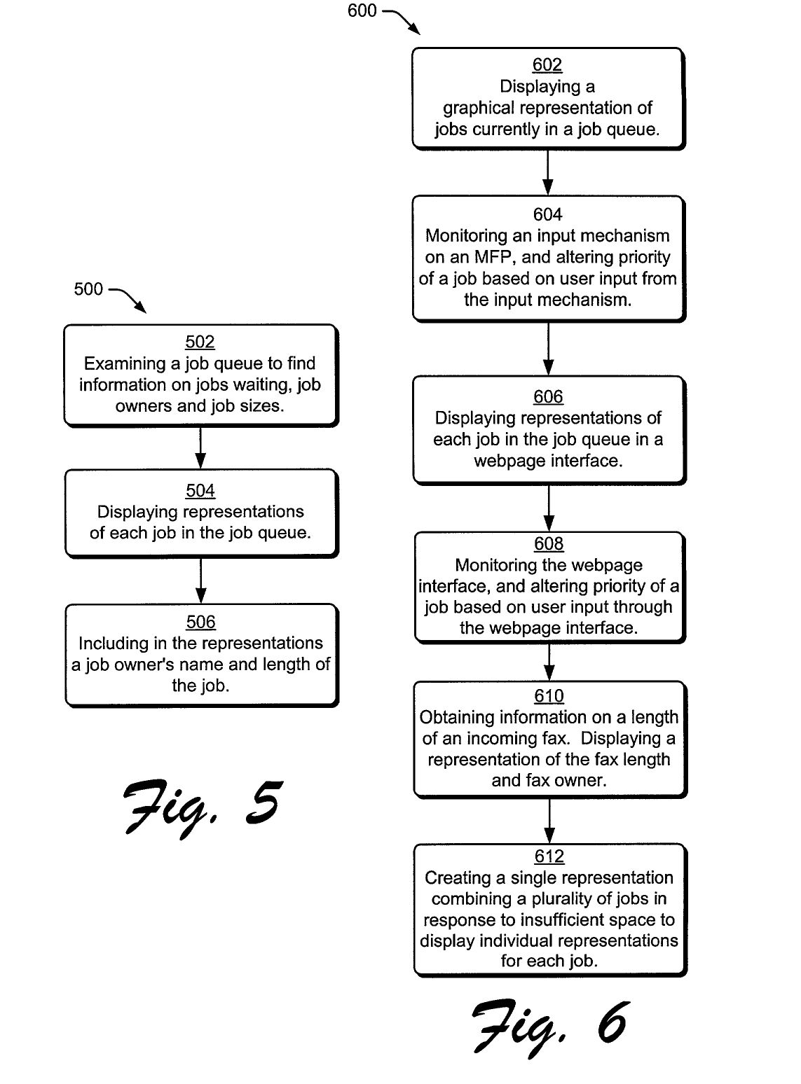

The flow chart of FIG. 5 illustrates an embodiment 500 for providing information about a job queue and for outputting data from a multifunctional peripheral, printer or other output device. The elements of the embodiment may be performed by any desired means, such as by the execution of processor-readable instructions defined on a processor-readable media, such as a disk, a ROM or other memory device. Also, actions described in any block may be performed in parallel with actions described in other blocks, may occur in an alternate order, or may be distributed with the actions associated with more than one other block.

At block 502, a job queue user interface driver or other designated device, object, or software procedure, examines the job queue to determine the number of jobs within the queue, and the length and ownership of those jobs.

At block 504, descriptions, representations or icons showing each job found in the job queue are displayed.

At block 506, the descriptions, representations or icons may be enhanced to reveal the ownership and length of the unprinted portion of each job in the job queue. Where only the first job within the job queue is being processed (i.e. two jobs are not being processed at the same time, such as printing an in-coming fax and scanning a document), the length variable associated with the representation of the first job may be constantly changed to reflect the number of pages which remain to be printed, or other similar factor.

The flow chart of FIG. 6 illustrates an embodiment 600 reciting additional optional means by which information about a job queue and for outputting data from a multifunctional peripheral, printer or other output device may be provided. The elements of the embodiment may be performed by any desired means, such as by the execution of processor-readable instructions defined on a processor-readable media, such as a disk, a ROM or other memory device. Also, actions described in any block may be performed in parallel with actions described in other blocks, may occur in an alternate order, or may be distributed with the actions associated with more than one other block.

At block 602, a graphical representation of jobs currently in a job queue is displayed. This may be done in a manner such as that described in embodiment 500 of FIG. 5.

At block 604, an input mechanism (such as keypad 202 of FIG. 2) is monitored, such as by a job queue user interface driver. Where appropriate, the priority of a job is altered based on user input. For example, the user input may be made through a keypad, wherein the key strokes are monitored by an appropriate driver. Upon receipt of the user's input, the priority of the job may be altered.

At block 606, representations of each job in the job queue may be displayed, on a webpage, which is served or sent by an embedded server within the multifunction peripheral typically to a workstation from which a job has been, or will be, sent. The webpage may be accessed by users of the printer to determine the approximate wait they will encounter before completion of their job. Therefore, the webpage may provide information that is considered by users when deciding to which printer or multifunction peripheral to send a job.

At block 608, the webpage interface is monitored, typically by the embedded web server, for information sent by workstations accessing the webpage. The information sent by a user on a workstation can include an alteration of the priority of any job under the ownership of the user.

At block 610, information is obtained on the length of an incoming fax. The fax is sent to the job queue, and a representation of the fax is displayed. The representation may include the fax owner and length, and may assist other users in determining the wait associated with their job, given the visual representation of the fax.

At block 612, in response to insufficient space on the output display to display individual representations for each job within the job queue, a single representation combining a plurality of jobs is created. Where the space available for display of representations of jobs would be exceeded by creation of individual representations of each job, a single representation may be created which combines several jobs into a single representation. For example, information associated with the last jobs within a print queue may be combined into a representation of an accumulated job, which includes the total pages of the last jobs in the job queue. As jobs are completed, job data is broken out of the representation of the accumulated job and is displayed in a separate job representation.

In conclusion, a progress meter for a peripheral, such as a multifunction peripheral (MFP) facilitates operation by allowing users to see a visual display of representations of jobs moving through a job completion process, each representation typically including a job owner indicator and a job length indicator. A user interface driver is configured to control the visual display. Job owners may easily see a representation of their job on the display, as well as other jobs and their lengths, and thereby estimate the time of completion of their job. In an alternative embodiment of the progress meter, an embedded web server sends a webpage interface to a user's workstation. The webpage is configured to provide an alternate display of the progress meter, and to allow users to select job priority for the jobs over which they exert ownership. In a further embodiment of the progress meter, a fax modem and fax upload/download utility are configured to obtain ownership and length information regarding incoming faxes, and to exhibit the information in the display. In still further embodiments of the progress meter, an input mechanism is configured to alter the status of jobs shown by the progress meter, such as to change the status to urgent, thereby resulting in processing prior to jobs of a lower status.

Although the disclosure has been described in language specific to structural features and/or methodological steps, it is to be understood that the appended claims are not limited to the specific features or steps described. Rather, the specific features and steps are exemplary forms of implementing this disclosure. For example, while the representations of jobs have been illustrated in a manner similar to icons, it is clear that the representations could be made in any form desired. In particular, the representations could be made to fit the style of the user interface supported by the operating system used.

Additionally, while one or more embodiments have been disclosed by means of flow charts and text associated with the blocks, it is to be understood that the blocks do not necessarily have to be performed in the order in which they were presented, and that an alternative order may result in similar advantages.

1. A peripheral, comprising:
a job queue;
a display, configured to present a plurality of representations of jobs resident within the job queue, each representation including a job owner indicator and a job length indicator; and
a user interface driver, configured to control the display.

2. The peripheral of claim 1, additionally comprising:
a bar graph, to provide an at-a-glance visual indication of an approximate percentage of completion of a job currently being processed.

3. The peripheral of claim 1, additionally comprising:
an imbedded web server; and
a webpage interface, served by the imbedded web server and configured to display a plurality of representations of jobs resident within the job queue.

4. The peripheral of claim 3, wherein the webpage interface is additionally configured to allow selection of job priority.

5. The peripheral of claim 1, additionally comprising:
a fax modem; and
a fax upload/download utility, interfaced to the fax modem and configured to obtain available fax length information, and additionally configured to transfer the fax length information to the user interface driver.

6. The peripheral of claim 1, additionally comprising:
an input mechanism to accept user commands; and
wherein the user interface driver is additionally configured to allow selection of job priority through the input mechanism.

7. The peripheral of claim 6, wherein job priority is selected from a group comprising: normal, urgent, nice and delete.

8. An apparatus, comprising:
a job queue;
a display, configured to display a plurality of representations of jobs, each representation including a job owner indicator and a job length indicator;
a bar graph, to provide an at-a-glance visual indication of an approximate percentage of completion of a job currently being processed;
a user interface driver, configured to control the display and the bar graph;
an imbedded web server; and
a webpage interface, served by the imbedded web server and configured to indicate job queue characteristics including representations for each job in the job queue having a job owner indicator and a job length indicator.

9. The apparatus of claim 8, wherein the webpage interface is additionally configured to allow selection of job priority.

10. The apparatus of claim 8, additionally comprising:
an input mechanism to accept user commands; and
wherein the user interface driver is additionally configured to allow selection of job priority through the input mechanism.

11. The apparatus of claim 10, wherein job priority is selected from a group comprising: normal, urgent, nice and delete.

12. The apparatus of claim 8, additionally comprising:
a fax modem; and
a fax upload/download utility, interfaced to the fax modem and configured to obtain available fax length information, and additionally configured to transfer the fax length information to the user interface driver.

13. An apparatus, comprising:
a job queue;
a display, configured to display a plurality of representations of jobs, each representation including a job owner indicator and a job length indicator;
a user interface driver, configured to control the display;
a fax modem; and
a fax upload/download utility, interfaced to the fax modem and configured to obtain available fax length information, and additionally configured to transfer the fax length information to the user interface driver.

14. The apparatus of claim 13, additionally comprising:
an imbedded web server;
a webpage interface, served by the imbedded web server and configured to indicate print queue characteristics; and
wherein the webpage interface is additionally configured to allow selection of job priority.

15. The apparatus of claim 14, additionally comprising:
an input mechanism to accept user commands; and
wherein the user interface driver is additionally configured to allow selection of job priority through the input mechanism, wherein job priority is selected from a group comprising: normal, urgent, nice and delete.

16. A processor-readable medium comprising processor-executable instructions for:
examining a job queue to find jobs within the job queue;
displaying representations of jobs within the job queue on a job queue display; and
for each representation, displaying a job owner indicator and a job length indicator.

17. A processor-readable medium as recited in claim 16, comprising further instructions for:
obtaining a length of a fax; and
displaying a representation of the fax including a job owner indicator and a job length indicator.

18. A processor-readable medium as recited in claim 16, comprising further instructions for:
displaying representations of each job in the job queue in a webpage interface; and
monitoring the webpage interface; and
altering priority of jobs based on user input through the webpage interface.

19. A processor-readable medium as recited in claim 16, comprising further instructions for:
monitoring an input mechanism to receive a user command; and
altering a job priority according to information received from the input mechanism.

20. A processor-readable medium as recited in claim 16, comprising further instructions for:
in response to insufficient space to display individual representations for each job, creating a single representation combining a plurality of jobs.

21. A method for outputting data, comprising:
examining a job queue to find jobs within the job queue;
displaying representations of jobs within the job queue on a job queue display; and
for each representation, displaying a job owner indicator and a job length indicator.

22. A method as recited in claim 21, additionally comprising:
obtaining a length of a fax; and
displaying a representation of the fax including a job owner indicator and a job length indicator.

23. A method as recited in claim 22, additionally comprising:
displaying representations of each job in the job queue in a webpage interface; and
monitoring the webpage interface; and
altering priority of a job based on user input through the webpage interface.

24. A method as recited in claim 23, additionally comprising:
monitoring an input mechanism to receive a user command; and
altering a job priority according to information received from the input mechanism, wherein the job priority is selected from among urgent, normal, nice and delete.

25. A method as recited in claim 24, additionally comprising:
in response to insufficient space to display individual representations for each job, creating a single representation combining a plurality of jobs.

26. An apparatus, comprising:
means for examining a job queue to find jobs within the job queue;
means for displaying representations of jobs within the job queue on a job queue display; and
means for displaying a job owner indicator and a job length indicator with each representation.

27. An apparatus as recited in claim 26, additionally comprising:
means for obtaining a length of a fax; and
means for displaying a representation of the fax including a job owner indicator and a job length indicator.

28. An apparatus as recited in claim 27, additionally comprising:
means for displaying representations of each job in the job queue in a webpage interface; and
means for monitoring the webpage interface; and
means for altering priority of a job based on user input through the webpage interface.

29. An apparatus as recited in claim 28, additionally comprising:
means for monitoring an input mechanism to receive a user command; and
means for altering a job priority according to information received from the input mechanism.

30. An apparatus as recited in claim 29, additionally comprising:
in response to insufficient space to display individual representations for each job, means for creating a single representation combining a plurality of jobs.
